(19) United States
(12) Patent Application Publication
(10) Pub. No.: US 2026/0087317 A1
(43) Pub. Date: Mar. 26, 2026

(54) MACHINE LEARNING METHOD AND INFORMATION PROCESSING APPARATUS

(71) Applicant: Fujitsu Limited, Kawasaki-shi (JP)

(72) Inventors: Yuichiro WADA, Setagaya (JP); Akira NAKAGAWA, Sagamihara (JP); Kimihiro YAMAZAKI, Ohta (JP); Mutsuyo WADA, Funabashi (JP); Takashi KATOH, Kawasaki (JP)

(73) Assignee: Fujitsu Limited, Kawasaki-shi (JP)

(21) Appl. No.: 19/407,748

(22) Filed: Dec. 3, 2025

Related U.S. Application Data
(63) Continuation of application No. PCT/JP2023/021090, filed on Jun. 7, 2023.

(51) Int. Cl. G06N 3/0455

(52) U.S. Cl. CPC G06N 3/0455

(57) ABSTRACT

An information processing apparatus inputs first data to an encoder to generate second data. The information processing apparatus adds noise whose magnitude is equal to or smaller than a threshold to the second data to generate third data. The information processing apparatus inputs the third data to a decoder to generate fourth data. The information processing apparatus performs training of the encoder and the decoder based on a loss function including an error term indicative of an error between the first data and the fourth data and a correction term indicative of a probability calculated from the second data by using a plurality of probability distributions each having a variance according to the threshold.

### CROSS-REFERENCE TO RELATED APPLICATION

This application is a continuation application of International Application PCT/JP2023/021090 filed on Jun. 7, 2023, which designated the U.S., the entire contents of which are incorporated herein by reference.

### FIELD

The embodiments discussed herein are related to a machine learning method and an information processing apparatus.

### BACKGROUND

One machine learning model is an autoencoder (self-encoder) including an encoder and a decoder. The encoder converts input data into feature data whose size is smaller than that of the input data. The decoder predicts the input data from the feature data. The autoencoder is sometimes used to compress the input data. Furthermore, the autoencoder is sometimes used to analyze the features of the input data.

A classification autoencoder has been proposed which calculates the mean and variance of a probability distribution from input data by using an encoder, randomly selects a sample from the probability distribution, and predicts the input data from the selected sample by using a decoder. In addition, an event prediction method has been proposed which predicts the occurrence of an event of a physical system by using an autoencoder. Furthermore, a machine learning system has been proposed which trains a variational autoencoder for converting input data into compressed data having a small amount of data.

Moreover, a learning device has been proposed which trains an autoencoder. The proposed learning device converts input data into feature data by using an encoder, adds noise to the feature data, and converts the feature data with the noise into output data by using a decoder. The learning device trains parameters of the autoencoder and the probability distribution of the feature data so as to minimize an error between the input data and the output data and the information entropy of the probability distribution of the feature data.

In addition, an image encoding device for encoding image data by using a machine learning model has been proposed. The proposed image encoding device converts image data into feature data of latent space, quantizes the feature data, and entropy-encodes the quantized feature data to generate a bit stream.
U.S. Patent Application Publication No. 2019/0095798
Japanese Laid-open Patent Application No. 2019-153279
U.S. Patent Application Publication No. 2021/0027169
International Publication Pamphlet No. WO2021/059349
Japanese Laid-open Patent Publication No. 2021-150955

### SUMMARY

In one aspect, there is provided a non-transitory computer-readable storage medium storing a computer program that causes a computer to perform a process including: generating second data by inputting first data to an encoder; generating third data by adding a noise whose magnitude is equal to or less than a threshold to the second data; generating fourth data by inputting the third data to a decoder; and performing training of the encoder and the decoder based on a loss function including an error term indicative of an error between the first data and the fourth data and a correction term indicative of a probability calculated from the second data by using a plurality of first probability distributions each having a first variance according to the threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for describing an information processing apparatus according to a first embodiment;

FIG. 2 illustrates a hardware example of an information processing apparatus according to a second embodiment;

FIG. 3 illustrates an example of the structure of an autoencoder;

FIG. 4 illustrates an example of the use of the autoencoder;

FIG. 5 illustrates examples of a rectangular window function and a Gaussian window function;

FIG. 6 illustrates an example of the correspondence between input data space and latent space;

FIG. 7 is a block diagram illustrative of an example of the function of an information processing apparatus;

FIG. 8 illustrates an example of the structure of a hyperparameter table;

FIG. 9 illustrates an example of the structure of iteration data; and

FIG. 10 is a flowchart illustrative of an example of a procedure for machine learning.

### DESCRIPTION OF EMBODIMENTS

A user sometimes wants to obtain an autoencoder having a distribution of feature data corresponding to the distribution of input data. As a property of the distribution of feature data, a user sometimes expects that the longer the distance between two pieces of input data becomes, the longer the distance between two pieces of feature data corresponding to the two pieces of input data becomes. This property may be called an isometric property. Furthermore, if the distribution of input a multimodal distribution having a plurality of peaks, then a user may expect that the distribution of feature data is also a multimodal distribution.

However, among the conventional machine learning techniques for training an autoencoder, there has been no machine learning technique for generating an autoencoder in which the distribution of feature data has an isoperimetric property and is a multimodal distribution.

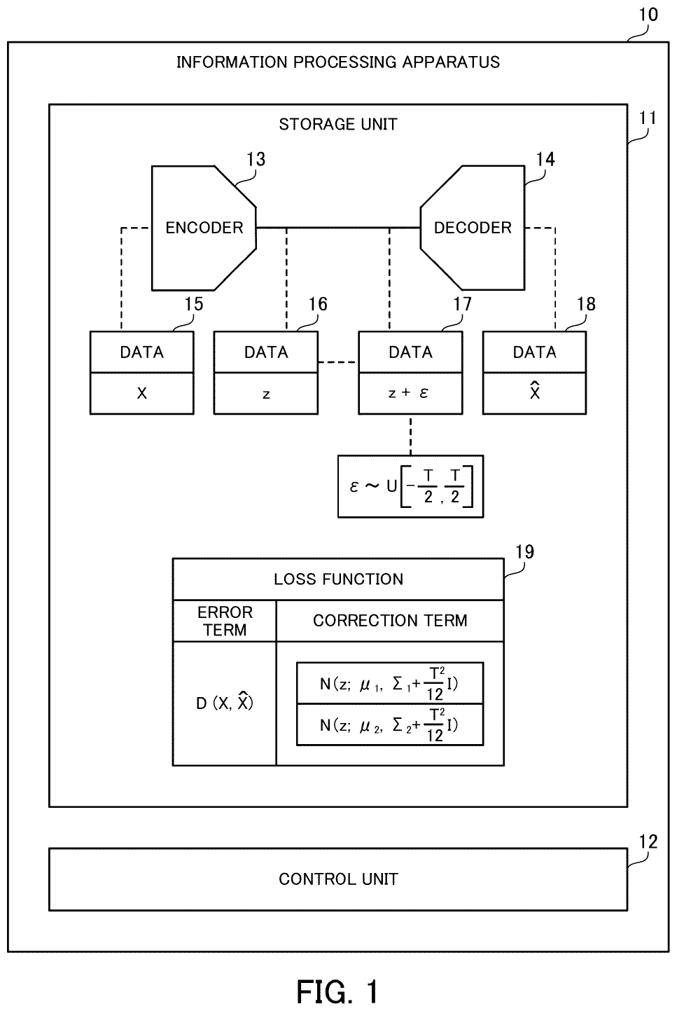

The embodiments will now be described with reference to the drawings. First, a first embodiment will be described. FIG. 1 is a view for describing an information processing apparatus according to a first embodiment. An information processing apparatus 10 according to the first embodiment performs machine learning for training an autoencoder by using training data. The information processing apparatus 10 may be a client apparatus or a server apparatus. The information processing apparatus 10 may be called a computer or a machine learning apparatus.

The information processing apparatus 10 has a storage unit 11 and a control unit 12. The storage unit 11 may be a volatile semiconductor memory such as a random access memory (RAM). Furthermore, the storage unit 11 may also be nonvolatile storage such as a hard disk drive (HDD) or a flash memory.

The control unit 12 is, for example, a processor such as a central processing unit (CPU), a graphics processing unit (GPU), or a digital signal processor (DSP). However, the control unit 12 may include an electronic circuit such as an application specific integrated circuit (ASIC) or a field programmable gate array (FPGA). The processor executes a program stored in, for example, a memory (which may also be the storage unit 11) such as a RAM. The processor may be referred to as a processor circuitry. A set of processors may be referred to as a multiprocessor or simply a “processor”. Different processes of a plurality of processes described later may be executed by different processors.

The storage unit 11 stores an encoder 13 and a decoder 14 included in an autoencoder. The autoencoder, the encoder 13 and the decoder 14 may be referred to as a machine learning model. Each of the encoder 13 and the decoder 14 includes a parameter whose value is updated by machine learning. The encoder 13 and the decoder 14 are, for example, a neural network including a plurality of layers. In that case, each of the parameters included in the encoder 13 and the decoder 14 is, for example, an edge weight between adjacent layers. Parameter values of the encoder 13 and the decoder 14 are initialized, for example, at the beginning of training.

The encoder 13 converts input data into feature data smaller in size than the input data. The feature data is, for example, a feature vector having fewer dimensions than the input data. The feature data may be referred to as latent variable data or a latent variable vector. The decoder 14 converts the feature data into output data larger in size than the feature data. The decoder 14 trained in combination with the encoder 13 predicts input data from the feature data.

Various kinds of input data are possible. The input data may be image data, audio data, natural language data, or other measurement data. Therefore, the autoencoder may be an image processing model, an audio processing model, a natural language processing model, or a measurement data analysis model.

The information processing apparatus 10 trains the encoder 13 and the decoder 14 so that the distribution of the feature data corresponds to the distribution of the input data. The expected properties of the distribution of the feature data include an isometric property and a multimodal property. The isometry means that the relative distance on the input data is preserved on the feature data. Therefore, the longer the distance between two pieces of input data becomes, the longer the distance between two pieces of feature data corresponding to the two pieces of input data becomes.

The multimodality means that the distribution of the feature data is a multimodal distribution having a plurality of peaks for appearance probability. The input data may be classified into a plurality of types, and the distribution of the input data may be a multimodal distribution having a plurality of peaks corresponding to the plurality of types. In that case, the distribution of the feature data may also preferably be a multimodal distribution. An autoencoder having isometry and multimodality is useful, for example, for analyzing the features of the input data.

The control unit 12 trains the encoder 13 and the decoder 14 by using training data. The training data may be unsupervised data to which no label is given. The control unit 12 generates data 16 from data 15 by inputting the data 15 to the encoder 13. The data 15 corresponds to the input data and the data 16 corresponds to the feature data.

The control unit 12 generates data 17 from the data 16 by adding noise whose magnitude is equal to or smaller than a threshold to the data 16. The data 17 corresponds to the feature data with the noise. If the data 16 is a vector including a plurality of dimensions, then, for example, the control unit 12 adds a random noise value whose magnitude is equal to or smaller than the threshold to an element value of each dimension. For example, the control unit 12 randomly selects a noise value from a uniform distribution having a numerical range whose absolute value is equal to or smaller than the threshold.

The control unit 12 inputs the data 17 to the decoder 14 to generate data 18 from the data 17. The data 18 corresponds to output data and is interpreted as a prediction result of the data 15. The control unit 12 performs training of the encoder 13 and the decoder 14 based on the data 15, 16, and 18 and a loss function 19. At this time, the control unit 12 updates parameter values of the encoder 13 and the decoder 14 so that the value of the loss function 19 becomes smaller.

The value of the loss function 19 may be referred to as loss. The loss function 19 may be referred to as an error function, a cost function, or an objective function. The control unit 12 may propagate loss information from the end of the decoder 14 toward the head of the encoder 13 by an error back-propagation method. Furthermore, the control unit 12 may update the parameter values by a stochastic gradient descent method.

The loss function 19 includes an error term and a correction term. The error term indicates an error between the data 15 and the data 18. The error is calculated by using, for example, a distance function. The distance is, for Euclidean distance. The correction term example, indicates a probability calculated for the data 16 under a certain probability distribution. The correction term in the first embodiment uses a plurality of probability distributions, each of which has variance corresponding to the above threshold for noise. For example, the correction term specifies a weighted sum of a plurality of probabilities calculated for the data 16 by the plurality of probability distributions.

Each probability distribution may be a normal distribution (Gaussian distribution) and the plurality of probability distributions may form a Gaussian mixture model (GMM). The superposition of the plurality of probability distributions represents a multimodal distribution with a plurality of peaks (maxima) of probability density. Each peak is a vertex with a probability density greater than those of surrounding points.

The plurality of probability distributions may be estimated based on an output of the encoder 13. The probability indicated by the correction term is, for example, an approximate value of a probability obtained by integrating the probability densities of the feature data within the range of the above threshold from the data 16 in the latent space, that is to say, probability densities in the vicinity of the data 16. The smaller an error indicated by the error term is, the smaller a value of the loss function 19 becomes. The larger a probability indicated by the correction term is, the smaller a value of the loss function 19 becomes. A negative sign may be attached to the correction term.

The correction term may be an approximate expression defined in the following way. An original correction term, for example, extracts a probability density in the vicinity of the data 16 from each of an original plurality of probability distributions by a rectangular window function, integrates the extracted probability densities in the vicinity, and calculates a weighted sum of a plurality of integral values corresponding to the plurality of probability distributions. The original plurality of probability distributions are estimated so as to fit some pieces of feature data converted by the encoder 13 from some pieces of input data.

The rectangular window function outputs 1 for feature data having a difference less than the above threshold from the data 16, and outputs 0 for the other feature data. The difference from the data 16 is less than the threshold means, for example, that the absolute value of the difference between element values for all dimensions included in a vector is less than the threshold. Therefore, by multiplying each probability distribution by the rectangular window function and integrating it, a neighborhood probability obtained by integrating probability densities of the feature data having a difference less than the threshold from the data 16 is calculated.

However, the original correction term, which multiplies a plurality of probability distributions by the rectangular window function and integrates them, is sometimes not differentiable, and it is sometimes difficult to use it for machine learning. Therefore, the control unit 12 approximates the rectangular window function by a Gaussian window function. The Gaussian window function is, for example, a smooth probability density function whose mean is 0 and whose variance is the same as that of the rectangular window function. If the threshold of noise is T/2 (T is a positive constant), then the variance of the Gaussian window function is T²/12. The Gaussian window function outputs a maximum value of 1 to feature data having a difference of 0 from the data 16. The larger the difference from the data 16 becomes, the smaller an output value of the Gaussian window function becomes.

If the rectangular window function is approximated by the Gaussian window function, then the window function and an integral operation are eliminated from an approximation equation by expanding the approximation equation. An approximated correction term is differentiable and is usable for machine learning. The magnitude of the probability density and the variance of the original probability distribution are corrected by multiplying the original probability distribution by the Gaussian window function and performing integration. Probability density becomes a constant multiple of the original probability distribution. Variance becomes larger than that of the original probability distribution. For example, variance becomes larger than that of the original probability distribution by the variance of the Gaussian window function. Therefore, the variance of each probability distribution included in the approximated correction term depends on the threshold of noise.

As has been described, the information processing apparatus 10 according to the first embodiment inputs the data 15 to the encoder 13 to generate the data 16. The information processing apparatus 10 adds noise whose magnitude is equal to or smaller than the threshold value to the data 16 to generate the data 17. The information processing apparatus 10 inputs the data 17 to the decoder 14 to generate the data 18. The information processing apparatus 10 performs training of the encoder 13 and the decoder 14 based on the loss function 19 including the error term and the correction term. The error term indicates an error between the data 15 and the data 18. The correction term indicates a probability calculated from the data 16 by using a plurality of probability distributions each having variance corresponding to a threshold.

Because the correction term depending on the threshold of noise is included in the loss function 19, the trained autoencoder acquires an isometric property. Furthermore, because the correction term indicates a superposition of a plurality of probability distributions, the distribution of feature data also becomes a multimodal distribution if the distribution of input data is a multimodal distribution. Therefore, an autoencoder useful for analyzing the feature of the input data is obtained.

Furthermore, because the correction term is approximated by using a plurality of probability distributions each having variance corresponding to the threshold of noise, it becomes easy to perform machine learning for updating parameter values of the encoder 13 and the decoder 14 so as to reduce a value of the loss function 19. Therefore, an autoencoder having a distribution of feature data corresponding to a distribution of input data is obtained.

The information processing apparatus 10 may estimate a plurality of second probability distributions based on the data 16, or may convert the plurality of second probability distributions into a plurality of first probability distributions included in the correction term based on the threshold of noise. As a result, the distribution of feature data is optimized in addition to the encoder 13 and decoder 14 through machine learning.

In addition, the information processing apparatus 10 may calculate a first variance of the above plurality of first probability distributions by adding third variance corresponding to the threshold of noise to second variance of the above plurality of second probability distributions. By doing so, the correction term is approximated to facilitate machine learning using the loss function 19. Furthermore, the third variance may be variance of the rectangular window function that outputs 1 if the absolute value of an input value is less than a threshold and outputs 0 if the absolute value of the input value is greater than or equal to the threshold. As a result, the correction term approximates a probability calculated by using the rectangular window function.

Furthermore, the information processing apparatus 10 may repeatedly perform a process for generating the data 16 and a process for estimating the plurality of second probability distributions. In this case, the information processing apparatus 10 may calculate a first parameter value defining the plurality of second probability distributions estimated in a first iteration by using a second parameter value calculated in a second iteration before the first iteration in addition to the data 16. As a result, the distribution of estimated feature data is stabilized and estimation accuracy is improved. Moreover, the convergence of the distribution of the feature data is accelerated.

A second embodiment will now be described. An information processing apparatus 100 according to the second embodiment performs machine learning for training an autoencoder using training data. Furthermore, the information processing apparatus 100 performs a prediction process using an encoder or a decoder included in the trained autoencoder. However, the machine learning and the prediction process may be performed by different information processing apparatuses. The information processing apparatus 100 may be a client apparatus or a server apparatus. The information processing apparatus 100 may be referred to as a computer or a machine learning apparatus. The information processing apparatus 100 corresponds to the information processing apparatus 10 according to the first embodiment.

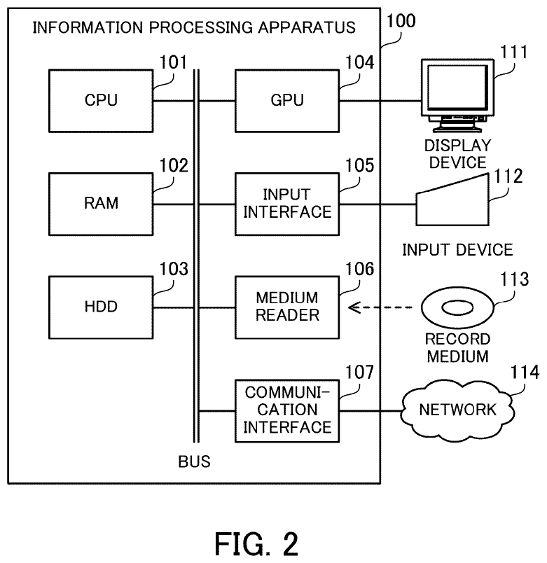

FIG. 2 illustrates a hardware example of the information processing apparatus according to the second embodiment. The information processing apparatus 100 includes a CPU 101, a RAM 102, an HDD 103, a GPU 104, an input interface 105, a medium reader 106, and a communication interface 107 connected to a bus. The CPU 101 corresponds to the control unit 12 in the first embodiment. The RAM 102 or the HDD 103 corresponds to the storage unit 11 in the first embodiment.

The CPU 101 is a processor for executing instructions of a program. The CPU 101 loads a program and data stored in the HDD 103 into the RAM 102 and executes the program. The information processing apparatus 100 may include a plurality of processors.

The RAM 102 is a volatile semiconductor memory for temporarily storing the program executed by the CPU 101 and the data used for calculation by the CPU 101. The information processing apparatus 100 may include a type of volatile memory other than a RAM.

The HDD 103 is nonvolatile storage for storing an operating system (OS), software programs such as middleware and application software, and data. The information processing apparatus 100 may include another type of nonvolatile storage such as a flash memory or a solid state drive (SSD).

The GPU 104 performs image processing in cooperation with the CPU 101 and outputs an image to a display device 111 connected to the information processing apparatus 100. The display device 111 is, for example, a cathode ray tube (CRT) display, a liquid crystal display, an organic electro luminescence (EL) display, or a projector. Another type of output device, such as a printer, may be connected to the information processing apparatus 100.

Furthermore, the GPU 104 may be used as a general purpose computing on graphics processing unit (GPGPU). The GPU 104 may execute a program in response to instructions from the CPU 101. The information processing apparatus 100 may include a volatile semiconductor memory other than the RAM 102 as a GPU memory.

The input interface 105 receives an input signal from an input device 112 connected to the information processing apparatus 100. The input device 112 is, for example, a mouse, a touch panel, or a keyboard. A plurality of input devices may be connected to the information processing apparatus 100.

The medium reader 106 is a reader for reading a program and data recorded on a record medium 113. The record medium 113 is, for example, a magnetic disk, an optical disk, or a semiconductor memory. The magnetic disk includes a flexible disk (FD) and an HDD. The optical disk includes a compact disk (CD) and a digital versatile disk (DVD). The medium reader 106 copies a program and data read from the record medium 113 to another record medium such as the RAM 102 or the HDD 103. The read program may be executed by the CPU 101.

The record medium 113 may be a portable record medium. The record medium 113 may be used for distributing a program and data. Furthermore, the record medium 113 and the HDD 103 may be referred to as a computer-readable record medium.

A communication interface 107 communicates with another information processing apparatus via a network 114. The communication interface 107 may be a wired communication interface connected to a wired communication device, such as a switch or a router, or a wireless communication interface connected to a wireless communication device, such as a base station or an access point.

An autoencoder will now be described. The autoencoder in the second embodiment has an isometric property in which distance on latent space is proportional to distance on input data. This autoencoder may be referred to as a variational autoencoder (VAE). An example of an autoencoder having an isometric property is a rate-distortion optimization guided autoencoder for generative analysis (RaDOGAGA).

RaDOGAGA is also described in the following non-patent document. Keizo Kato, Jing Zhou, Tomotake Sasaki and Akira Nakagawa, “Rate-Distortion Optimization Guided Autoencoder for Isometric Embedding in Euclidean Latent Space,” Proc. of the 37th International Conference on Machine Learning (ICML 2020), pp. 5166-5176, July 2020.

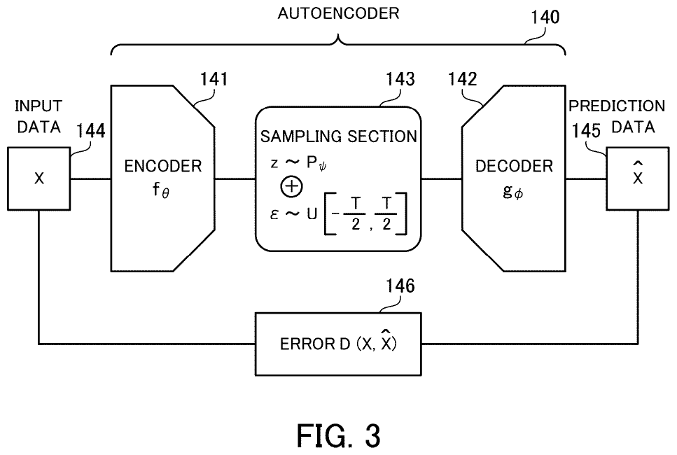

FIG. 3 illustrates an example of the structure of the autoencoder. An autoencoder 140 includes an encoder 141 and a decoder 142. Each of the encoder 141 and the decoder 142 is a neural network including a plurality of layers. The encoder 141 is expressed as function f_{θ} including parameter θ. The decoder 142 is expressed as function g_{φ} including parameter φ. The parameters θ and φ include edge weights between adjacent layers. The values of the parameters θ and φ are calculated through machine learning.

The encoder 141 receives input data 144 and converts the input data 144 into a latent variable vector. The latent variable vector may be referred to as feature data or a feature vector. The input data 144 is a vector including a plurality of dimensions. The number of dimensions of the latent variable vector is smaller than that of the input data 144. Therefore, the encoder 141 compresses the input data 144 to express the features of the input data 144 by a small vector.

The decoder 142 receives the latent variable vector and converts the latent variable vector into prediction data 145. The prediction data 145 is a vector including a plurality of dimensions. The number of dimensions of the prediction data 145 is larger than that of the latent variable vector and is usually the same as that of the input data 144. If the latent variable vector outputted from the encoder 141 is inputted to the decoder 142, then the prediction data 145 indicates a prediction result of the input data 144.

In order to make the latent variable vector follow a fixed probability distribution, the information processing apparatus 100 uses a sampling section 143 at the time of training the autoencoder 140. The sampling section 143 adds random noise to each dimension of the latent variable vector outputted from the encoder 141. The noise is randomly selected from a uniform distribution having a numerical range from −T/2 to T/2. The uniform distribution is a probability distribution indicative that all events occur with an equal probability. T is a hyperparameter taking a positive value and indicates noise width.

The information processing apparatus 100 inputs the latent variable vector to which noise is added to the decoder 142. The information processing apparatus 100 calculates an error 146 between the input data 144 and the prediction data 145. The error 146 is calculated by using distance function D. For example, the error 146 is Euclidean distance between the input data 144 and the prediction data 145. However, a distance index other than the Euclidean distance may be used.

The information processing apparatus 100 updates values of parameters θ and φ so that a value of a loss function including the error 146 becomes smaller. For example, the information processing apparatus 100 propagates loss information from the end of the decoder 142 toward the head of the encoder 141 by an error back-propagation method. For example, the information processing apparatus 100 calculates a gradient from the loss information and current values of parameters θ and φ by a stochastic gradient descent method and updates values of parameters θ and φ by using the calculated gradient. Latent space forms a constant probability distribution by adding noise to the latent variable vector.

Values of parameters θ and φ are updated in mini-batches including a fixed number of data records corresponding to the input data 144. The mini-batches are extracted from a training data set prepared in advance. Each data record of the training data set may be unlabeled, and machine learning of the autoencoder 140 may be unsupervised learning.

The information processing apparatus 100 generates a plurality of latent variable vectors by inputting each of a plurality of data records included in a mini-batch to the encoder 141. The information processing apparatus 100 adds noise to each of the plurality of latent variable vectors. The information processing apparatus 100 generates a fixed number of data records corresponding to prediction data 145 by inputting each of a plurality of latent variable vectors with noise to the decoder 142.

The plurality of latent variable vectors generated from one mini-batch follows probability distribution P_{ψ} having parameter ψ. For example, the probability distribution P_{ψ} is a normal distribution, and the parameter ψ includes a mean and variance. The information processing apparatus 100 estimates the value of the parameter ψ by fitting a plurality of latent variable vectors to a normal distribution for each mini-batch.

The loss function includes an error term indicative of an average error of a plurality of data records included in a mini-batch. The information processing apparatus 100 updates values of the parameters θ and φ so that a value of the loss function becomes smaller for each mini-batch. The information processing apparatus 100 repeats extracting a mini-batch, calculating a value of the loss function, and updating values of the parameters θ and φ. The information processing apparatus 100 may repeat the above process until the number of iterations reaches a fixed number. Furthermore, the information processing apparatus 100 may repeat the above process until values of the parameters θ and φ converge.

In order to make the latent space have an isometric property, the loss function includes a correction term in addition to the error term. The correction term calculates a probability indicative of the certainty of the latent variable vector following the probability distribution P_{ψ}. The correction term uses a probability distribution P_{ψ} estimated each mini-batch. The correction term indicates the average probability of a plurality of latent variable vectors corresponding to a plurality of data records included in a mini-batch. The larger the probability becomes, the smaller a value of the loss function becomes. Because a latent variable vector with noise inputted to the decoder 142 has the fluctuation of noise width T, a probability indicated by the correction term is the integral of probability density in the range of the width T centered on the generated latent variable vector.

The loss function will now be described further. Equation (1) is an example of the loss function used in the second embodiment. In equation (1), m is mini-batch size, Xᵢ is the ith input data record included in a mini-batch, X\hat{ }ᵢ is the ith prediction data record, D is a distance function, β is a hyperparameter taking a positive value, and zᵢ is a latent variable vector generated from Xᵢ. Q_{zi} is a probability that a latent variable vector in the vicinity of zᵢ appears in the latent space. D(Xᵢ, X\hat{ }ᵢ) corresponds to the error term, and −β log Q_{zi} corresponds to the correction term.

$$arg {min}_{θ , ϕ} \frac{1}{m} {\sum }_{i = 1}^{m} \{ D ( {X}_{i} , {\hat{X}}_{i} ) - βlog {Q}_{{z}_{i}} \} \qquad ( 1 )$$

The probability Q_{zi} is defined by equation (2). In equation (2), z is a latent variable as a random variable, U(z) is a rectangular window function, and P_{ψ}(z) is a probability density function. The rectangular window function U(z) is defined by equation (3). In equation (3), zⱼ is an element value of the jth dimension in an argument vector. If element values of all dimensions are greater than −T/2 and smaller than T/2, then the rectangular window function U(z) outputs 1. If an element value of at least one dimension is not in the above numerical range, then the rectangular window function U(z) outputs 0.

$${Q}_{{z}_{i}} = {\int }_{- ∞}^{∞} U ( z - {z}_{i} ) {P}_{ψ} ( z ) dz \qquad ( 2 )$$

$$U ( z ) = \{ \begin{matrix}1 & ∀ {z}_{j} ∈ z [ - \frac{T}{2} < {z}_{j} < \frac{T}{2} ] \\ 0 & else\end{matrix} \qquad ( 3 )$$

Therefore, U(z−zᵢ) in equation (2) outputs 1 for the latent variable vector z within the range of T/2 from the latent variable vector zᵢ, and outputs 0 for other latent variable vectors z. Therefore, the probability Q_{zi} is a probability obtained by integrating the probability density of the latent variable vectors z within the range of T/2 from the latent variable vector zᵢ.

If a probability in the vicinity of the latent variable vector zᵢ is large, then it may be said that zᵢ sufficiently follows the probability distribution P_{ψ}. Therefore, the correction term reduces a value of the loss function. On the other hand, if a probability in the vicinity of the latent variable vector zᵢ is small, it may be said that zᵢ does not sufficiently follow the probability distribution P_{ψ}. Therefore, the correction term increases a value of the loss function. It may be said that the correction term adds a penalty corresponding to a latent variable vector to the error term.

Next, we consider making the probability distribution of the latent space a multimodal distribution. If input data are classified into a plurality of clusters, then the probability distribution of the input data may become a multimodal distribution with a plurality of peaks of probability density. The multimodal distribution is represented by, for example, a mixed Gaussian model. In the mixed Gaussian model, a probability distribution is represented by the weighted sum of a plurality of normal distributions. In this case, the probability distribution of the latent space may also preferably become a multimodal distribution. By representing the latent space by a multimodal distribution, the accuracy of the isometric property of the latent space may also be improved.

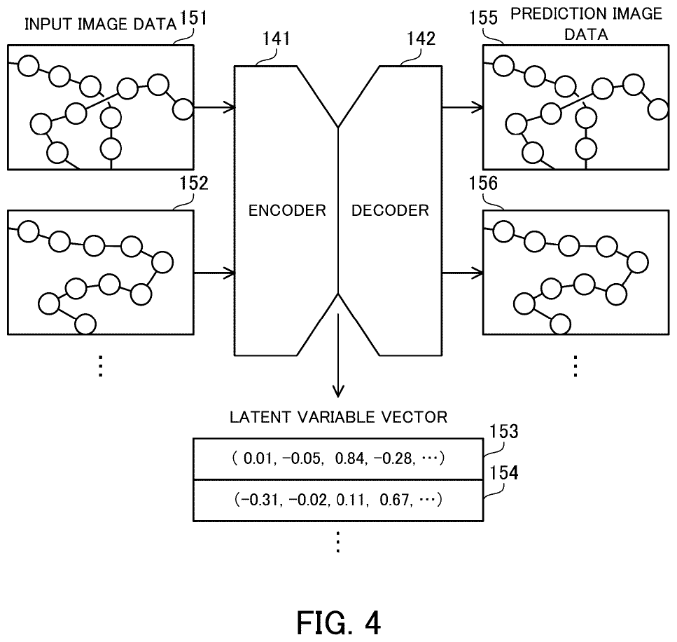

FIG. 4 illustrates an example of the use of the autoencoder. An example of input data inputted to the encoder 141 is image data. The encoder 141 converts the image data into a latent variable vector whose data size is sufficiently smaller than that of the image data. The decoder 142 reproduces the image data from the latent variable vector.

For example, the encoder 141 generates a latent variable vector 153 from input image data 151. The encoder 141 also generates a latent variable vector 154 from input image data 152. A user may analyze the features of an input image data group including the input image data 151 and 152 by viewing the probability distribution of a latent variable vector group including the latent variable vectors 153 and 154. For example, the user classifies input image data into a plurality of clusters based on the probability distribution of the latent space. Furthermore, for example, the user extracts features common to similar input image data based on the probability distribution of the latent space.

In addition, for example, the decoder 142 generates prediction image data 155 from the latent variable vector 153. The prediction image data 155 is a prediction result of the input image data 151. Furthermore, the decoder 142 generates prediction image data 156 from the latent variable vector 154. The prediction image data 156 is a prediction result of the input image data 152. At the time of prediction, it may be that noise is not added to a latent variable vector inputted to the decoder 142.

By inputting a latent variable vector similar to a known latent variable vector to the decoder 142, the user may generate image data different from known input image data. This increases variations in image data. Furthermore, the user analyzes the correspondence between image data and latent variables.

As described above, the encoder 141 and the decoder 142 may be trained in combination at the time of training, while each may be used independently at the time of prediction. A machine learning model for estimating a probability distribution from observed data may be referred to as a generative model.

An example of the input image data 151 and 152 is a protein structure image indicative of the molecular structure of protein. Because protein structure is exceedingly complicated, it is difficult for the user to directly analyze a protein structure image. Therefore, the user may analyze the features of the protein structure by using the probability distribution of the latent space.

Various protein structures may include similar protein structures and dissimilar protein structures, and various protein structures may be classified into a plurality of clusters. Therefore, the probability distribution of a protein structure image may be a multimodal distribution. Furthermore, in order to analyze protein structure by using the latent space, it is preferable that the latent space have an isometric property. Therefore, it is preferable that the encoder 141 and the decoder 142 be trained so that the probability distribution of the latent space becomes a multimodal distribution having an isometric property.

As described above, in the machine learning of the autoencoder 140, it is sometimes preferable that the probability distribution of the latent space be a multimodal distribution having an isometric property. However, when the mixed Gaussian model is substituted for the probability density function P_{ψ}(z) in the above equation (2), it is sometimes difficult for the information processing apparatus 100 to analytically solve the probability Q_{zi}.

The integral of the product of the rectangular window function and a plurality of normal distributions is non-differentiable and the probability Q_{zi} becomes non-differentiable. Therefore, machine learning using the error back-propagation method and the stochastic gradient descent method is sometimes difficult. In particular, if the latent variable z is a high-dimensional vector, then it is difficult to analytically solve the probability Q_{zi}, and it is also difficult to use a library for obtaining an approximate value of a probability by using a number table.

Therefore, the information processing apparatus 100 replaces the probability Q_{zi} in the above equation (2) with a differentiable approximate equation. For this purpose, the information processing apparatus 100 approximates the rectangular window function U(z) in the above equation (3) by Gaussian window function G(z) defined by equation (4).

$$G ( z ) = exp ( - \frac{{‖ z ‖}^{2}}{2 {σ}^{2}} ) = \sqrt{2 π} {σ}^{d} 𝒩 ( z ; 0 , {σ}^{2} {I}_{d} ) \qquad ( 4 )$$

In equation (4), d is the number of dimensions of the latent space and I_{d} is a unit matrix of d rows and d columns. N(z; μ, Σ) is a normal distribution having z as a random variable, μ as a mean vector, and Σ as a variance-covariance matrix. σ² is variance specified by equation (5) by using noise width T. The variance σ² is the variance of the Gaussian window function G(z) and is set equal to the variance of the rectangular window function U(z) with width T.

$${σ}^{2} = \frac{{T}^{2}}{12} \qquad ( 5 )$$

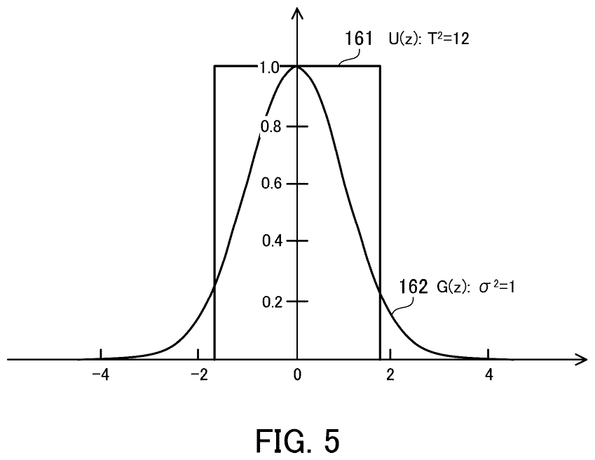

FIG. 5 illustrates examples of the rectangular window function and the Gaussian window function. Curve 161 illustrates the rectangular window function U(z). Curve 162 illustrates the Gaussian window function G(z). In FIG. 5, it is assumed that T²=12 and σ²=1.

Weight outputted by the Gaussian window function G(z) is a numeric value between 0 and 1. The Gaussian window function G(z) outputs the maximum value 1 if a value of an argument is 0. The weight outputted by the Gaussian window function G(z) decays as a value of the argument moves away from 0. Although curve 162 has the shape of a normal distribution, its amplitude is different from the probability density of the normal distribution. An output of G(z) is a constant multiple of probability density defined by the normal distribution whose mean is 0 and whose variance is σ².

In the above equation (2), if the mixed Gaussian model is substituted for the probability density function P_{ψ}(z) and U(z−zᵢ) for the rectangular window function is approximated by G(z−zᵢ) for the Gaussian window function, then the probability Q_{zi} is approximated as in equation (6).

$$\begin{matrix}{Q}_{{z}_{i}} \approx {\int }_{- ∞}^{∞} G ( z - {z}_{i} ) {P}_{ψ} ( z ) dz \\ = {\int }_{- ∞}^{∞} G ( z - {z}_{i} ) {\sum }_{c = 1}^{C} {π}_{c} 𝒩 ( z ; {μ}_{c} , {\sum }_{c} ) dz\end{matrix} \qquad ( 6 )$$

In equation (6), C is the number of clusters. One cluster appearing in the latent space is represented by one normal distribution. Therefore, C corresponds to the number of normal distributions. π_{c} is a mixing coefficient indicative of the weight of a c-th normal distribution, μ_{c} is a mean vector of the c-th normal distribution, and Σ_{c} is a variance-covariance matrix of the c-th normal distribution.

Applying equation (4) to G(z−zᵢ) in equation (6) and expanding the product of normal distributions and an integral operation, the probability Q_{zi} is finally approximated as equation (7). The window function and the integral operation are eliminated from the approximation equation of the probability Q_{zi}.

$$\begin{matrix}{Q}_{{z}_{i}} \approx {\int }_{- ∞}^{∞} \sqrt{2 π} {σ}^{d} 𝒩 ( z ; {z}_{i} , {σ}^{2} {I}_{d} ) {\sum }_{c = 1}^{C} {π}_{c} 𝒩 ( z ; {μ}_{c} , {\sum }_{c} ) dz \\ = {\sum }_{c = 1}^{C} {π}_{c} \sqrt{2 π} {σ}^{d} 𝒩 ( {z}_{i} ; {μ}_{c} , {\sum }_{c} + {σ}^{2} {I}_{d} )\end{matrix} \qquad ( 7 )$$

The approximation equation indicates that the probabilities of C normal distributions for a latent variable vector zᵢ are weighted by the mixing coefficient π_{c} and are added together, and takes the form of the mixed Gaussian model. However, unlike the original mixed Gaussian model estimated from a mini-batch, the probability of each normal distribution is multiplied by a constant. In addition, unlike the original mixed Gaussian model, the variance of each normal distribution is increased by σ². Therefore, the approximation equation includes a plurality of normal distributions each having variance σ² corresponding to the noise width T.

The approximation equation of the probability Q_{zi} indicated in equation (7) is differentiable because it is a closed-form equation. The closed-form equation is an equation that combines differentiable basic functions such as addition, multiplication, and an exponential function. Therefore, a loss function including the probability Q_{zi} is differentiable and the information processing apparatus 100 performs machine learning using the error back-propagation method and the stochastic gradient descent method. As a result, the autoencoder 140 is trained so that a latent variable vector follows a multimodal distribution having an isometric property.

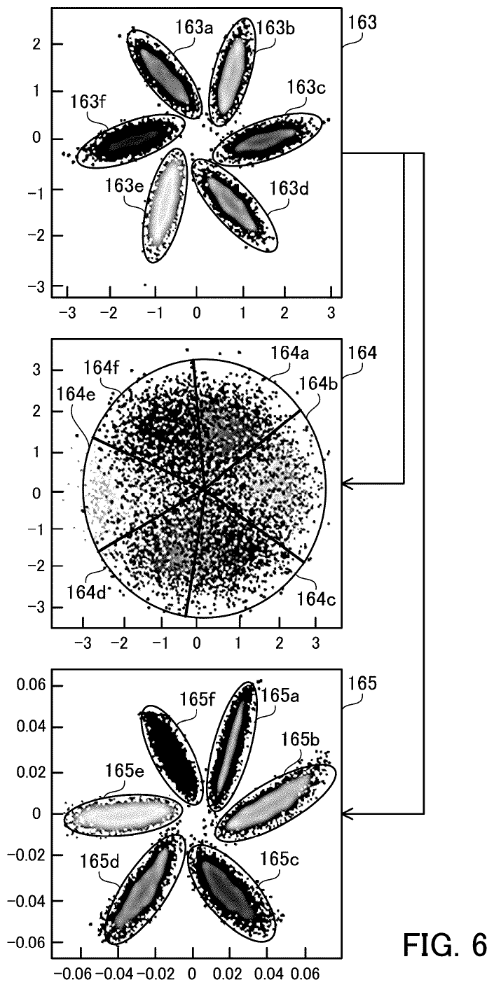

FIG. 6 illustrates an example of the correspondence between input data space and latent space. Graph 163 illustrates the probability distribution of input data space. Graph 163 illustrates a multimodal distribution including clusters 163a, 163b, 163c, 163d, 163e, and 163f.

Graph 164 illustrates the probability distribution of latent space obtained if the probability Q_{zi} is calculated by using a single normal distribution. Graph 164 includes clusters 164a, 164b, 164c, 164d, 164e, and 164f. The cluster 164a corresponds to the cluster 163a. The cluster 164b corresponds to the cluster 163b. The cluster 164c corresponds to the cluster 163c. The cluster 164d corresponds to the cluster 163d. The cluster 164e corresponds to the cluster 163e. The cluster 164f corresponds to the cluster 163f.

However, the clusters 164a, 164b, 164c, 164d, 164e, and 164f form a unimodal distribution and do not form a multimodal distribution. In addition, although similar latent variable vectors are generated from input data belonging to the same cluster, strictly speaking, an isometric property is not achieved. Therefore, there is room for improvement in the probability distribution of the latent space. A probability distribution expressed by a single normal distribution may also be interpreted that the mixing number of a mixed probability distribution is 1.

Graph 165 illustrates the probability distribution of the latent space obtained if the probability Q_{zi} is calculated by using the mixed Gaussian model. Graph 165 includes clusters 165a, 165b, 165c, 165d, 165e, and 165f. The cluster 165a corresponds to the cluster 163a. The cluster 165b corresponds to the cluster 163b. The cluster 165c corresponds to the cluster 163c. The cluster 165d corresponds to the cluster 163d. The cluster 165e corresponds to the cluster 163e. The cluster 165f corresponds to the cluster 163f.

The clusters 165a, 165b, 165c, 165d, 165e and 165f form a multimodal distribution corresponding to the input data space. Furthermore, an isometric property, in which distance on the latent space is proportional to distance on the input data space, is achieved. Therefore, the probability distribution indicated by graph 165 is useful for analyzing the features of input data.

Next, the optimization of the parameter ψ defining the probability distribution P_{ψ} will be described. As described above, a value of the parameter ψ is updated for each mini-batch and is updated a plurality of times during machine learning. If a value of the parameter ψ is updated once and a value after the update is calculated from only one mini-batch, then the value of the parameter ψ may become unstable due to the influence of contingency of data records included in the mini-batch. As a result, there is a risk that a value of the parameter θ defining the encoder 141 and a value of the parameter φ defining the decoder 142 fall into local solutions.

Therefore, the information processing apparatus 100 updates a value of the parameter ψ based on equations (8) to (10). At this time, the information processing apparatus 100 also refers to a value of the parameter ψ calculated in the previous mini-batch. The parameter ψ includes the mixing coefficient π_{c}, the mean vector μ_{c}, and the variance-covariance matrix Σ_{c} of each of C normal distributions. The information processing apparatus 100 first updates the mixing coefficient π_{c} according to equation (8), then updates the mean vector μ_{c} according to equation (9), and finally updates the variance-covariance matrix Σ_{c} according to equation (10).

$${π}_{c}^{( ℓ )} = {ξπ}_{c}^{( ℓ - 1 )} + ( 1 - ξ ) \frac{{\sum }_{i = 1}^{m} {p}_{i , c}}{m} \qquad ( 8 )$$

$${μ}_{c}^{( ℓ )} = ξ \frac{{π}_{c}^{( ℓ - 1 )}}{{π}_{c}^{( ℓ )}} {μ}_{c}^{( ℓ - 1 )} + ( 1 - ξ ) \frac{{\sum }_{i = 1}^{m} {p}_{i , c} {z}_{i}}{m {π}_{c}^{( ℓ )}} \qquad ( 9 )$$

$${\sum }_{c}^{( ℓ )} = ξ \frac{{π}_{c}^{( ℓ - 1 )}}{{π}_{c}^{( ℓ )}} {\sum }_{c}^{( ℓ - 1 )} + ( 1 - ξ ) \frac{{\sum }_{i = 1}^{m} {p}_{i , c} ( {z}_{i} - {μ}_{c}^{( ℓ )} ) {( {z}_{i} - {μ}_{c}^{( ℓ )} )}^{T}}{m {π}_{c}^{( ℓ )}} \qquad ( 10 )$$

In equation (8), π^{(l)}_{c} is the mixing coefficient of the c-th normal distribution calculated in the l-th iteration, and π^{(l-1)}_{c} is the mixing coefficient of the c-th normal distribution calculated at the l−1 iteration. ξ is a hyperparameter which takes a value from 0 to 1 and indicates the weight of the previous iteration. For example, ξ is from 0.95 to 0.99.

p_{i,c} is the probability that the latent variable vector zᵢ belongs to the c-th normal distribution. The encoder 141 outputs a C-dimensional feature vector wᵢ together with a d-dimensional latent variable vector zᵢ from input data Xᵢ. The feature vector wᵢ is a vector representing the features of the input data Xᵢ in C dimensions. The information processing apparatus 100 inputs an element value of each dimension of the feature vector wᵢ to a softmax function to calculate the assignment probability p_{i,c} taking a value of 0 to 1.

In equation (9), μ^{(l)}_{c} is the mean vector of the c-th normal distribution calculated in the lth iteration, and μ^{(l-1)}_{c} is the mean vector of the c-th normal distribution calculated in the l−1 iteration. In equation (10), Σ^{(l)}_{c} is the variance-covariance matrix of the c-th normal distribution calculated in the lth iteration, and Σ^{(l-1)}_{c} is the variance-covariance matrix of the c-th normal distribution calculated in the l−1 iteration. In the first iteration, π⁽¹⁾_{c}, μ⁽¹⁾_{c}, and Σ⁽¹⁾_{c} are calculated by assuming ξ=0.

As has been described, the information processing apparatus 100 slowly updates a value of the parameter ψ based on the value of the parameter ψ calculated in the previous mini-batch. Therefore, a value of the parameter ψ is stabilized through a plurality of mini-batches, and the risk that values of the parameters θ and φ fall into local solutions is reduced.

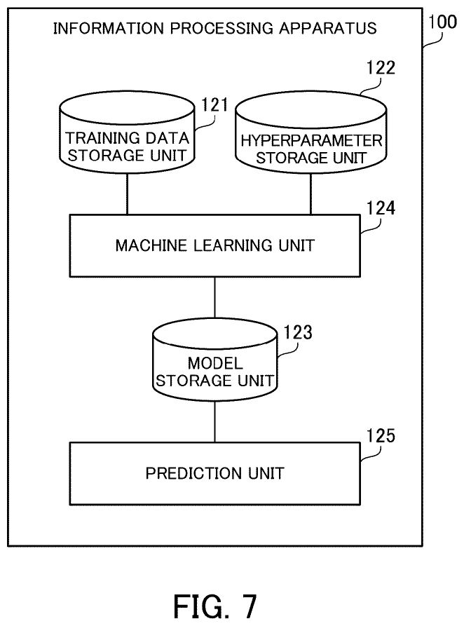

The function and processing procedure of the information processing apparatus 100 will now be described. FIG. 7 is a block diagram illustrative of an example of the function of the information processing apparatus. The information processing apparatus 100 includes a training data storage unit 121, a hyperparameter storage unit 122, a model storage unit 123, a machine learning unit 124, and a prediction unit 125. The training data storage unit 121, the hyperparameter storage unit 122, and the model storage unit 123 are implemented by using, for example, the RAM 102, the GPU memory, or the HDD 103. The machine learning unit 124 and the prediction unit 125 are implemented by using, for example, the CPU 101 or the GPU 104 and a program.

The training data storage unit 121 stores a training data set. The training data set includes a plurality of data records. For example, the training data set includes a plurality of image data records. Each data record may be unlabeled.

The hyperparameter storage unit 122 stores values of hyperparameters used for machine learning. The values of the hyperparameters are specified by, for example, a user. The values of the hyperparameters are specified before the beginning of machine learning. The model storage unit 123 stores a trained autoencoder as a trained machine learning model. The trained autoencoder includes an encoder and a decoder trained in combination.

The machine learning unit 124 trains the autoencoder by using the training data set stored in the training data storage unit 121 and the values of the hyperparameters stored in the hyperparameter storage unit 122. At this time, the machine learning unit 124 extracts a mini-batch from the training data set, inputs each data record included in the mini-batch to the autoencoder to calculate a value of a loss function, and feeds back the value of the loss function to update a parameter value of the autoencoder. The machine learning unit 124 repeats the above process.

The machine learning unit 124 saves the trained autoencoder in the model storage unit 123. The machine learning unit 124 may display the trained autoencoder on the display device 111 or may transmit the trained autoencoder to another information processing apparatus.

The prediction unit 125 reads the autoencoder from the model storage unit 123. The prediction unit 125 performs a prediction process by using the encoder or the decoder in response to an input from the user. For example, the prediction unit 125 inputs designated input data to the encoder to extract the features of the input data. In addition, the prediction unit 125 inputs a designated latent variable vector to the decoder to generate prediction data having the latent variable vector as a feature. The prediction unit 125 may save a result of the prediction process in nonvolatile storage, display the result on the display device 111, or transmit the result to another information processing apparatus.

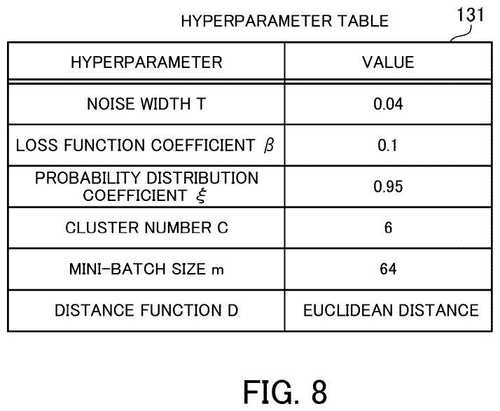

FIG. 8 illustrates an example of the structure of a hyperparameter table. A hyperparameter table 131 is stored in the hyperparameter storage unit 122. Hyperparameter values of a plurality of hyperparameters are registered in the hyperparameter table 131. The hyperparameters include noise width T, a loss function coefficient β, a probability distribution coefficient ξ, a cluster number C, mini-batch size m, and a distance function D.

The noise width T adjusts the magnitude of noise added to a latent variable vector at machine learning time. The loss function coefficient β is the weight of a correction term compared with an error term included in a loss function. The probability distribution coefficient ξ adjusts the amount of update at one time at the time of updating a value of the parameter ψ of the probability distribution P_{ψ}. The cluster number C is the number of types of input data. The mini-batch size m is the number of data records included in one mini-batch. The distance function D is a function for calculating an error between input data and prediction data, and calculates, for example, Euclidean distance.

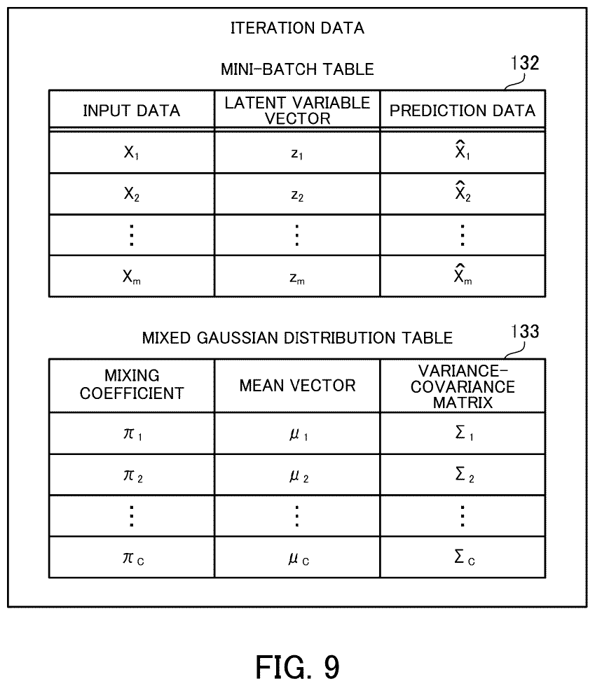

FIG. 9 illustrates an example of the structure of iteration data. Iteration data generated for each mini-batch include a mini-batch table 132 and a mixed Gaussian distribution table 133. The mini-batch table 132 and the mixed Gaussian distribution table 133 are generated by the machine learning unit 124.

The mini-batch table 132 associates input data X₁, X₂, . . . , and Xₘ with latent variable vectors z₁, z₂, . . . , and zₘ and the prediction data X\hat{ }₁, X\hat{ }₂, . . . , and X\hat{ }ₘ respectively. The latent variable vector zᵢ is generated by inputting the input data Xᵢ to an encoder. The prediction data X\hat{ }ᵢ is generated by adding noise to the latent variable vector zᵢ and inputting the latent variable vector zᵢ to a decoder.

The mixed Gaussian distribution table 133 associates mixing coefficients π₁, π₂, . . . , and π_{C} with mean vectors μ₁, μ₂, . . . , and μ_{c}, and variance-covariance matrices Σ₁, Σ₂, . . . , and Σ_{C} respectively. The mixing coefficient I_{c}, the mean vector μ_{c}, and the variance-covariance matrix Σ_{c} are calculated from π_{c}, μ_{c}, and Σ_{c} of the previous iteration and the latent variable vectors z₁, z₂, . . . and zₘ of the current iteration.

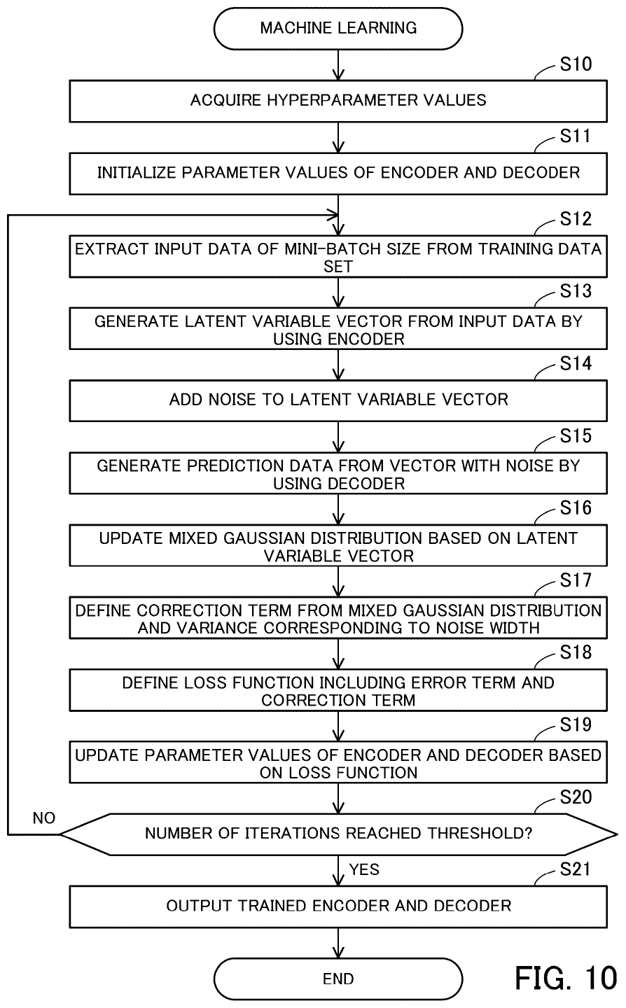

FIG. 10 is a flowchart illustrative of an example of a procedure for machine learning. The machine learning unit 124 acquires hyperparameter values. For example, the machine learning unit 124 reads hyperparameter values from the hyperparameter table 131. Hyperparameters include T, β, ξ, C, m, and D (S10). The machine learning unit 124 initializes parameter values of an encoder and a decoder included in an autoencoder (S11).

The machine learning unit 124 extracts input data of mini-batch size m from a training data set. At this time, the machine learning unit 124 preferably extracts unused input data preferentially (S12). The machine learning unit 124 generates a latent variable vector from the input data by using the encoder (S13). The machine learning unit 124 adds noise to the latent variable vector. At this time, the machine learning unit 124 adds noise randomly selected from a uniform distribution of −T/2 to T/2 to each dimension included in the latent variable vector (S14).

The machine learning unit 124 generates prediction data from the latent variable vector with the noise by using the decoder (S15). The machine learning unit 124 updates a mixed Gaussian distribution based on a mixed Gaussian distribution of the previous iteration and the latent variable vector generated in step S13. However, in the first iteration, the machine learning unit 124 estimates a mixed Gaussian distribution based on the latent variable vector generated in step S13 (S16).

The machine learning unit 124 modifies the mixed Gaussian distribution updated in step S16 by using variance σ² calculated from noise width T to define a probability Q_{zi} and define a correction term including the probability Q_{zi} (S17). The machine learning unit 124 defines a loss function including an error term indicative of an error between the input data and the prediction data and the correction term in step S17 (S18).

The machine learning unit 124 updates the parameter values of the encoder and the decoder so that a value of the loss function in step S18 becomes smaller (S19). The machine learning unit 124 determines whether the number of iterations of steps S12 to S19 has reached a threshold. If the number of iterations has reached the threshold, then the process proceeds to step S21. if the number of iterations has not reached the threshold, then the process returns to step S12 (S20).

The machine learning unit 124 outputs the trained encoder and decoder. The machine learning unit 124 may save the encoder and the decoder in nonvolatile storage, display them on the display device 111, or transmit them to another information processing apparatus (S21).

As has been described, the information processing apparatus 100 according to the second embodiment adds noise having the noise width T to a latent variable vector outputted by the encoder, and inputs the latent variable vector to the decoder. As a result, the autoencoder is trained so that the latent variable z follows a fixed probability distribution.

Furthermore, the information processing apparatus 100 adds a correction term indicative of a probability within the range of the width T centered on the generated latent variable vector to the loss function. As a result, an isometric property such that the distance between two latent variable vectors is proportional to the distance between input data corresponding to the latent variable vectors is obtained. In addition, the information processing apparatus 100 expresses a probability distribution used for the correction term by the mixed Gaussian model. As a result, if the probability distribution of the input data is a multimodal distribution, then the latent variable z also follows the multimodal distribution. Therefore, latent space useful for analyzing the features of the input data is obtained.

Moreover, the information processing apparatus 100 approximates the rectangular window function used for the correction term by the Gaussian window function. As a result, a window function and an integral operation are eliminated from the approximation equation of the correction term. The approximation equation multiplies the probability density of the original mixed Gaussian model by a constant and increases the variance of the original mixed Gaussian model by variance σ² corresponding to the noise width T. Therefore, even if the mixed Gaussian model is used, the loss function becomes a differentiable function and the error back-propagation method and the stochastic gradient descent method are easily executed.

In addition, instead of estimating the mixed Gaussian model only from a mini-batch of the current iteration, the information processing apparatus 100 inherits parameter values of the mixed Gaussian model of the previous iteration by the weight ξ. As a result, the mixed Gaussian model is stabilized through a plurality of iterations, and the risk that parameter values of the autoencoder fall into local solutions is reduced.

In one aspect, an autoencoder having the distribution of feature data corresponding to the distribution of input data is generated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
generating second data by inputting first data to an encoder;
generating third data by adding a noise whose magnitude is equal to or less than a threshold to the second data;
generating fourth data by inputting the third data to a decoder; and
performing training of the encoder and the decoder based on a loss function including an error term indicative of an error between the first data and the fourth data and a correction term indicative of a probability calculated from the second data by using a plurality of first probability distributions each having a first variance according to the threshold.

2. The non-transitory computer-readable storage medium according to claim 1, wherein the training includes estimating, based on the second data, a plurality of second probability distributions each having a second variance and converting, based on the threshold, the plurality of second probability distributions into the plurality of first probability distributions.

3. The non-transitory computer-readable storage medium according to claim 2, wherein the converting includes calculating the first variance by adding a third variance corresponding to the threshold to the second variance.

4. The non-transitory computer-readable storage medium according to claim 3, wherein the third variance is a variance of a rectangular function that outputs 1 in response to an absolute value of an input value being less than the threshold and that outputs 0 in response to the absolute value being greater than or equal to the threshold.

5. The non-transitory computer-readable storage medium according to claim 2, wherein:
the generating of the second data and the estimating are iteratively performed; and
the estimating includes calculating a first parameter value indicative of the plurality of second probability distributions estimated in a first iteration from the second data generated in the first iteration and a second parameter value indicative of the plurality of second probability distributions estimated in a second iteration before the first iteration.

6. A machine learning method comprising:
inputting, by a processor, first data to an encoder to generate second data;
adding, by the processor, a noise whose magnitude is equal to or less than a threshold to the second data to generate third data;
inputting, by the processor, the third data to a decoder to generate fourth data; and
training, by the processor, the encoder and the decoder based on a loss function including an error term indicative of an error between the first data and the fourth data and a correction term indicative of a probability calculated from the second data by using a plurality of first probability distributions each having a first variance according to the threshold.

7. An information processing apparatus comprising:
a memory configured to store an encoder and a decoder; and
a processor coupled to the memory and the processor configured to:
input first data to the encoder to generate second data;
add a noise whose magnitude is equal to or less than a threshold to the second data to generate third data;
input the third data to the decoder to generate fourth data; and
perform training of the encoder and the decoder based on a loss function including an error term indicative of an error between the first data and the fourth data and a correction term indicative of a probability calculated from the second data by using a plurality of first probability distributions each having a first variance according to the threshold.
